(19) United States
(12) Patent Application Publication
(10) Pub. No.: US 2004/0091255 A1
(43) Pub. Date: May 13, 2004

(54) Camera flash circuit with adjustable flash illumination intensity

(75) Inventors: Scott B. Chase, Rochester, NY (US); Douglas W. Constable, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/292,097

(22) Filed: Nov. 11, 2002

(51) Int. Cl. G03B 15/03

(52) U.S. Cl. 396/176

(57) ABSTRACT

A flash control circuit is provided for a flash circuit having a flash capacitor and a flash illumination device. The flash control circuit comprises a current limiting device in series with the flash illumination device and a bypass circuit in parallel with the current limiting device. The bypass circuit has a first setting that bypasses the current limiting device and a second setting that does not bypass the current limiting device.

### FIELD OF THE INVENTION

The present invention relates to flash circuits having adjustable flash illumination intensity.

### BACKGROUND OF THE INVENTION

Many flash cameras do not adjust the amount of flash output based upon subject distance picture taking situations. The flash output for these cameras is typically fixed and set at a light discharge level that sufficiently illuminates an optimum range of distances from the camera.

However this flash strategy risks over exposing scene elements that are closer to the camera than the optimum range and risks under exposing scene elements which are at distances beyond the optimum range. Some cameras have so called quench circuits which measure the amount of light reflected from the scene during flash light discharge and shut down the release of flash light when the amount of light reflected by the scene reaches a predetermined light level. One example of a quench circuit is found in Japanese Pat. Pub. No. 2002-99031A, entitled “Strobe Apparatus” filed by Katsumi, on Sep. 25, 2000. Another example is found in U.S. Pat. No. 5,111,233, entitled “Electronic Flash Device” filed by Yokonuma et al., on Jun. 25, 1991. Because quench circuits require real time sensing and interpretation of the reflected light, quench circuits can be complex and expensive.

Alternatively, cameras are known with flash circuits having a user settable switch that changes the amount of energy stored in a flash capacitor. The energy is discharged through a strobe which converts this energy into flash illumination. The amount of light released by the strobe is proportional to the amount of charge that is stored in the flash capacitor prior to discharge. Accordingly, when the amount of energy stored in the flash capacitor is reduced, the amount of light emitted by the strobe is reduced. In such cameras, a camera user sets the switch for either long or short picture taking distances and the amount of flash energy that is stored in the flash capacitor is increased or decreased respectively. One example of such a circuit is found in Japanese Pat. Pub. No. 2002-169252A, entitled “Film Unit with Lens” filed by Hirokazu, on Dec. 1, 2000. In the '252 publication a user controllable switch is settable in one of two positions for either “long distance”, which provides full flash energy, or “short distance”, which bleeds down some of the flash voltage from a flash capacitor prior to the flash discharge. Similarly, another example of such a circuit is described in Japanese Pat. Pub. No. 2002-139818A entitled “Film Unit with Lens” filed by Hirokazu et al., on Nov. 1, 2000. In this publication, the flash circuit has a switch that can be set by a user to one of two positions: a “close” photographing position which causes a limited amount of energy to be stored in the flash capacitor, and a “normal” photographing position which causes a full amount of flash energy to be stored in the flash capacitor. These circuits involve complex circuitry to achieve the objective of providing a flash circuit with an adjustable flash intensity. Further, in these circuits, a trigger pulse voltage is used to trigger a flash discharge. This trigger voltage is dependent upon the charge on the flash capacitor. Storing a reduced amount of energy in the flash capacitor has the effect of reducing the trigger pulse voltage, which may cause unreliable triggering.

Thus, what is needed is a simpler and more reliable camera flash circuit that adapts the light output of a flash to reflect the distance from the camera to the subject of the scene.

### SUMMARY OF THE INVENTION

In one aspect of the present invention a flash control circuit is provided for a camera flash circuit having a flash capacitor and a flash illumination device. The flash control circuit has a current limiting device in series with the flash capacitor and the flash illumination device and a bypass circuit in parallel with the current limiting device. The bypass circuit has a first setting that bypasses the current limiting device and a second setting that does not bypass the current limiting device. In another aspect of the present invention, a flash circuit is provided. The flash circuit has a flash illumination device and a flash capacitor connected in series with the flash illumination device. A flash charging circuit stores energy in the flash capacitor and a trigger circuit controllably discharges the energy stored in the capacitor through the flash illumination device so that the flash illumination device emits a flash of light. A current limiting device is electrically connected in series with the flash capacitor and flash illumination device. A switch is in parallel with the current limiting device with the switch being selectably settable between a closed setting that bypasses the current limiting device and an open setting that does not bypass the current limiting device, so that when the switch is open and a discharge of energy from the flash capacitor is triggered, the discharged energy is shared by the flash illumination device and the current limiting device.

In another aspect of the invention, a camera is provided. The camera has a taking lens unit to focus light from a scene onto a film with the taking lens having an adjustable focus setting. A shutter system controllably exposes the film to light from the scene. A flash illumination device and a flash capacitor are connected in series. A flash charging circuit stores energy in the flash capacitor and a trigger circuit controllably discharges the energy stored in the capacitor through the flash illumination device so that the flash illumination device emits a flash of light. A current limiting device is in series with the flash capacitor and flash illumination device and a switch in parallel with the current limiting device with the switch being selectably settable between a closed setting that bypasses the current limiting device and an open setting that does not bypass the current limiting device, so that when the switch is open and a discharge of energy from the flash capacitor is triggered, the discharged energy is shared by the flash illumination device and the current limiting device. The switch and the taking lens unit are joined so that the setting of the flash circuit is determined by the setting of the taking lens unit.

### BRIEF DESCRIPTION OF THE DRAWINGS

FIG. 1 shows an illustration of a single use camera in which the present invention is particularly useful.

FIG. 2 shows a schematic diagram of one embodiment of the circuit of the present invention.

FIG. 3 shows a schematic diagram of another embodiment of the present invention.

FIGS. 4-6 show a diagram illustrating one embodiment of the invention wherein the flash illumination intensity adjustment is integrated with the operation of an adjustable system for a camera.

FIGS. 7-9 show a diagram illustrating another embodiment of the invention wherein the flash illumination intensity adjustment is integrated with an adjustment member.

FIG. 10 shows a schematic diagram illustrating a further embodiment of the present invention.

### DETAILED DESCRIPTION OF THE INVENTION

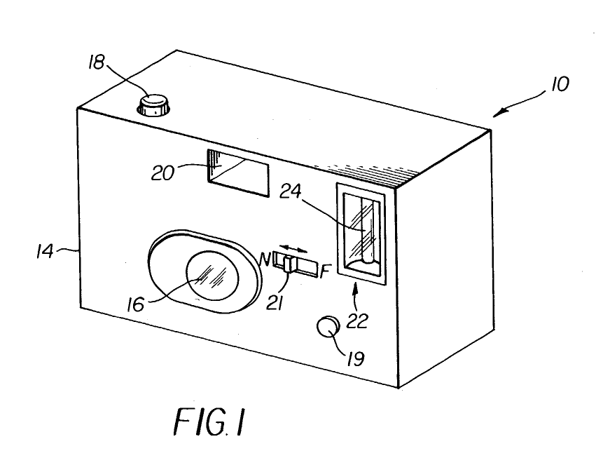

Referring to FIG. 1, there is depicted a low cost, single use embodiment of a camera 10 including a body 14, an optical system 16, a viewfinder 20 and a flash assembly 22 including a flash illumination device 24 shown in this embodiment as a flash tube. A shutter button 18 initiates a picture taking sequence which opens and closes a shutter (not shown) to expose a film (not shown) through optical system 16. Opening of the shutter also actuates an internal flash sync switch to a closed position, thereby initiating supplemental scene illumination from flash illumination device 24. A “one-touch” button 19, operable by the camera user, initiates a flash charging cycle to charge a flash capacitor to provide energy for operation of the flash illumination device 24. Camera 10 is pointed at the intended subject with the aid of viewfinder 20.

A switch 21 is provided for movement between a full flash light emission position and a reduced flash light emission position. In the embodiment shown, switch 21 is a user controlled switch accessible on the outside of camera 10. The positions of switch 21 are labeled as shown in FIG. 1 to indicate which position is for far photographs and which position is for near photographs.

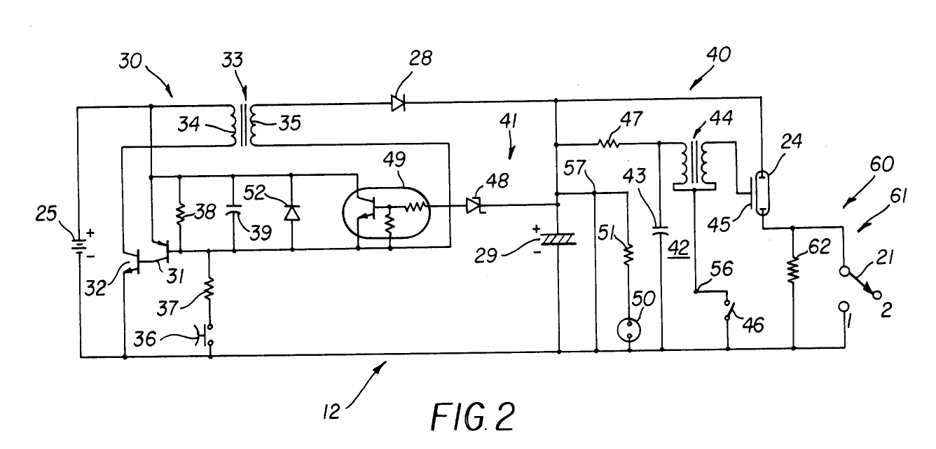

Turning now to FIG. 2, there is shown a circuit arrangement for the camera 10. As shown therein, flash circuit 12 includes a self-oscillating flash charging circuit 30 and a flash illumination circuit 40. In the embodiment shown, flash charging circuit 30 comprises first and second oscillating transistors 31, 32, a step-up oscillation transformer 33 having primary winding 34 and secondary winding 35, and a rectifier diode 28. Transistor 31 can comprise any general purpose transistor. For example, a transistor such as any MPSA reference number T3904LT transistor or like device can be used. Transistor 32 can comprise a transistor such as a Japan Electronics and Information Industries Association (JEITA) reference number 2SD879 transistor or like device. A manually operated, normally open, momentary switch 36, closable by depression of “one-touch” button 19 on camera 10, is coupled from the negative terminal of power supply battery 25 via a resistor 37 to the base of first oscillation transistor 31. When momentary switch 36 is closed, a positive potential is applied to the base of transistor 31 turning on both transistors 31 and 32 to initiate oscillatory pulses through primary winding 34. These pulses are stepped up in the secondary winding 35 and rectified by diode 28 to charge a main flash capacitor 29. Feedback current from the secondary winding 35 sustains the oscillatory condition, even when “one-touch” button is released to open switch 36 thereby removing the positive bias on the base of transistor 31.

A resistor 38 is connected between the base of transistor 31 and ground and serves to prevent the oscillation circuit 30 from commencing charging when exposed to static electricity. Resistor 38 holds the DC potential on the base of transistor 31 at the potential of the positive terminal of power supply battery 25 when the oscillation circuit is off. Thus, any static electricity induced current that would otherwise flow through the junctions of transistors 31 and 32 is bypassed to a positive terminal of power supply battery 25 and does not inadvertently start the charging circuit. The value of resistor 38 relative to that of resistor 37 is chosen to ensure that the bases of transistors 31 and 32 are forward biased when switch 36 is closed. Various combinations of values for resistors 37 and 38 can be used to meet the condition of ensuring that the bases of transistors 31 and 32 are forward biased when switch 36 is closed. For example, combination resistor 37 can have a value of 1.5 kilohms, while in this example, resistor 38 has a value of 22 kilohms.

Diode 52 protects the base-emitter junction of transistor 31 from reverse bias noise spikes. Capacitor 39 improves the efficiency of the oscillations by giving a duty cycle of oscillation having an on period that is relatively longer than an off period. Capacitor 39 also protects transistor 31 by absorbing feedback spikes. Capacitor 39 can have a capacitance value that is between 100 picofarads and 10,000 picofarads. For example, capacitor 39 can have a value of 1000 picofarads.

Flash illumination circuit 40 includes flash capacitor 29, flash illumination device 24 and a flash trigger circuit 42. In this embodiment, flash illumination device 24 comprises a flash tube. However, in alternative embodiments, flash illumination device 24 can comprise one or more conventional light sources such as high intensity lamps or high intensity light emitting diodes.

Flash trigger circuit 42 comprises a trigger capacitor 43, isolation resistor 47, voltage converting transformer 44, flash triggering electrode 45 and a flash trigger switch 46 which may comprise a shutter/flash sync switch which is closed when the camera shutter is opened by depression of camera shutter button 18. Trigger capacitor 43 is charged by current flow through charging transformer secondary winding 35 at the same time and in similar manner as flash capacitor 29. Trigger capacitor 43 can have a capacitance value between 40 microfarads and 500 microfarads. For example trigger capacitor 43 can have a capacitance of 0.022 microfarads. Isolation resistor 47 can have a resistance between 470 kilohms and 10 megohms. For example, isolation resistor 47 can have a value of 1 megohm.

When switch 46 is closed during a picture-taking sequence, switch terminal 56, which is at the positive charge potential of flash capacitor 29, is pulled momentarily negative to the negative potential level of battery 25. Trigger capacitor 43 then discharges through the primary winding of voltage converting transformer 44, inducing a high voltage pulse of about 4.0 kilovolts in the secondary winding which is applied to triggering electrode 45. As noted above, in the embodiment of FIG. 2 flash illumination device 24 comprises a flash tube. Accordingly, in this embodiment, when the high voltage pulse is applied to triggering electrode 45 the gas in the flash tube is ionized resulting in flash capacitor 29 discharging through the flash tube embodiment of flash illumination device 24, exciting the gas and producing flash illumination.

Neon light 50 and current limiting resistor 51 connected in series across flash capacitor 29 comprise a ready light circuit to advise the camera user when sufficient charge is stored in capacitor 29, e.g. +270 volts, to sustain a flash illumination from flash tube 24. Current limiting resistor 51 can have a resistance between 10 kohms and 10 megohms. For example, current limiting resistor 51 can have a resistance of 47 kohms. Flash circuit 40 also includes an oscillation arresting circuit 41 comprising 320 volt zener diode 48 and an NPN switching transistor 49. Zener diode 48 can have a threshold voltage between 200 volts and 500 volts. For example, the threshold can be +320 volts. Transistor 49 can comprise a digital transistor such as an MPSA reference number A2211 transistor, or other like device. When charge voltage at flash capacitor 29 reaches full charge of for example, +320 volts, zener diode 48 breaks down and momentarily conducts, applying a positive bias on the base of transistor 49. This drives transistor 49 into conduction shunting the base of oscillation transistor 31 to the positive terminal of battery 25. This turns off transistors 31, 32 thereby stopping the oscillation in the charging circuit 30.

As is shown in FIG. 2, a flash intensity control circuit 60 is provided. In this embodiment, flash intensity control circuit 60 comprises a current limiting device 62 that is electrically connected in series with flash illumination device 24. A bypass circuit 61 is electrically connected in parallel with current limiting device 62. In the embodiment shown, bypass circuit 61 comprises switch 21. When switch 21 is set to the far photography position, switch 21 is closed which bypasses current limiting device 62. This permits all of the flash energy stored in flash capacitor 29 to be applied to flash illumination device 24 during a flash discharge. This, in turn, causes a high level of flash illumination to be discharged by flash illumination device 24. When switch 21 is set to the near position, switch 21 is open causing current to flow from the flash capacitor 29 through flash illumination device 24 and through current limiting device 62 during a flash discharge. Accordingly, the energy from flash capacitor 29 is shared between flash illumination device 24 and current limiting device 62. This reduces the intensity of the flash illumination that is discharged by flash illumination device 24.

In the embodiment that is shown in FIG. 2 current limiting device 62 comprises a resistor. In other embodiments, various other forms of resistor can be used. For example, a resistor that can be used for current limiting device 62 can comprise a conventional ceramic/wire resistor, a section of nickel chromium wire or a conventional copper circuit trace. Alternatively a resistor can be formed from a wire or circuit trace formed on a printed circuit board that are fabricated from other alloys or doped with other chemical materials that are selected to increase the effective resistance of the wire or circuit trace. A resistor can also be formed from the resistance of a printed circuit board trace having sufficient length. Such a trace can be patterned using an oscillating pattern so that the length can be fit into the geometry of a small circuit board.

Current limiting device 62 can also take other forms. For example an inductor can be used to provide impedance which will consume a portion of the energy provided by flash capacitor 29 during flash discharge. The use of an inductor also advantageously extends the duration of the discharge of flash light. Conveniently a suitable inductor can be formed on a printed circuit board by a circuit trace (not shown) having an oscillating pattern to extend the length of the circuit trace.

The resistance/impedance of current limiting device 62 can vary between 0.5 ohms and 25 ohms. For example, the resistance/impedance can be 1 ohm. The embodiment shown in FIGS. 1 and 2, flash intensity control circuit 60 provides two flash illumination intensity settings.

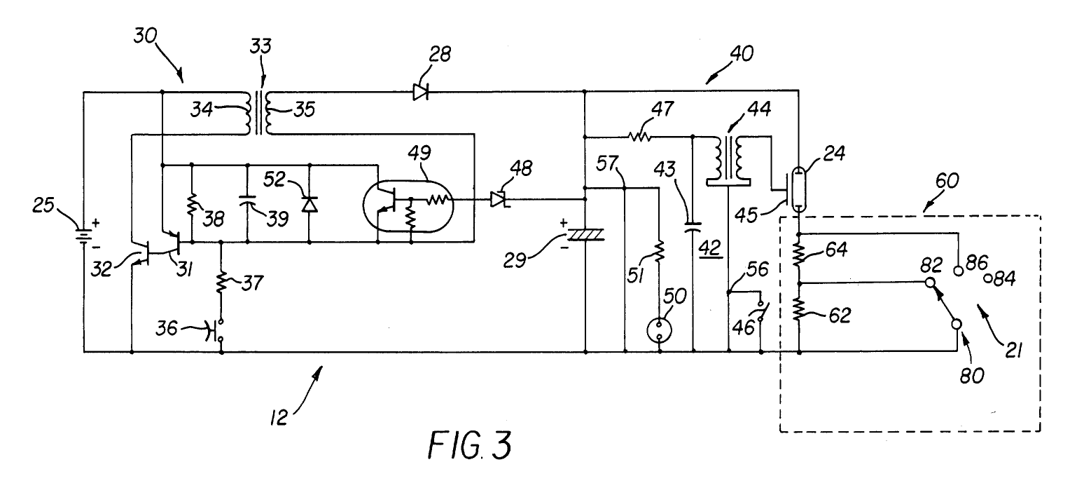

In an alternative embodiment shown in FIG. 3, the flash intensity control circuit 60 can provide a bypass circuit 61 with more than two flash illumination intensity settings. Where this is done, switch 21 provides one setting that connects current limiting device 62 in series with flash illumination device 24 and one setting that connects an additional current limiting device 64 in series with current limiting device 24 and current limiting device 62. A third setting shunts current limiting devices 62 and 64. Accordingly, the amount of light discharged by flash illumination device 24 during a flash discharge will vary depending upon the setting of switch 21.

To permit user control of the settings of a switch 21 having more than two settings, switch 21 can be arranged in a manner similar to the manner shown in FIG. 1 and as is described in with reference to FIG. 1, with the exterior modified to have markings that indicate the positions of the near, far and intermediate settings. This arrangement permits a user of camera 10 to choose between near, far, and intermediate photography positions.

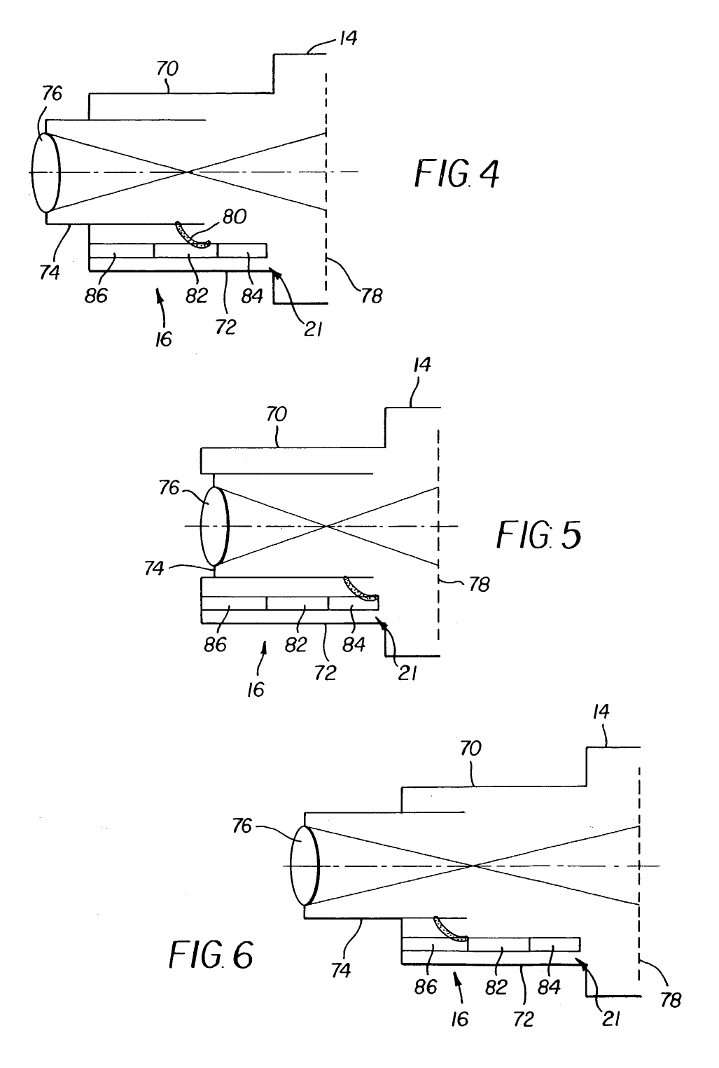

Switch 21 can also be automatically set by action of a user of camera 10. For example FIGS. 4, 5 and 6 show switch 21 integrated with the operation of a lens system 16 that incorporates an adjustable lens system 70. Lens system 70 can be adjusted for focus distance and/or telephoto. In the embodiment shown, adjustable lens system 70 has a stationary component 72 and a movable component 74 for moving optical elements 76 relative to an imaging plane 78. As shown in FIG. 4, when movable component 74 is positioned within a first range of positions that are relatively close to the imaging plane 78, focus system 70 is arranged to capture images of subjects that are close to camera 10. Switch 21 is arranged so that a movable contact 80 of switch 21 is positioned to engage a first stationary contact 82. In this embodiment, first stationary contact 82 is connected to current limiting device 62. With switch 21 so positioned, current limiting device 62 provides a load during flash discharge which reduces the amount of light discharged by the flash illumination device 24 to a level that is appropriate for intermediate distance photography.

As shown in FIG. 5, when movable component 74 of adjustable lens system 70 is positioned within a second range of positions beyond the first range of positions, movable contact 80 of switch 21 engages a second stationary contact 84. Second stationary contact 84 connects an additional current limiting device 64 in series with flash illumination device 24 and current limiting device 62 which provides a greater load than when current limiting device 62 alone is connected in series with flash illumination device 24. With switch 21 so positioned, current limiting device 64 provides a load during flash discharge which reduces the amount of light discharged by flash illumination device 24 to a level that is appropriate for near distance photography.

As is shown in FIG. 6, when movable component 74 of adjustable lens system 70 is positioned within a third range of positions beyond the first and second ranges, movable contact 80 of switch 21 is positioned to engage a third stationary contact 86. Third stationary contact 86 bypasses current limiting device 62 and additional current limiting device 64 so that the flash discharged by flash illumination device 24 is at a level that is appropriate for far distance photography. The first range, second range and third ranges of positions of moveable component 74 can be arranged to be equal or can vary. It will be appreciated that other adjustable lens structures and arrangements of switch 21 can be defined so that movement of adjustable lens components will automatically alter the settings of switch 21.

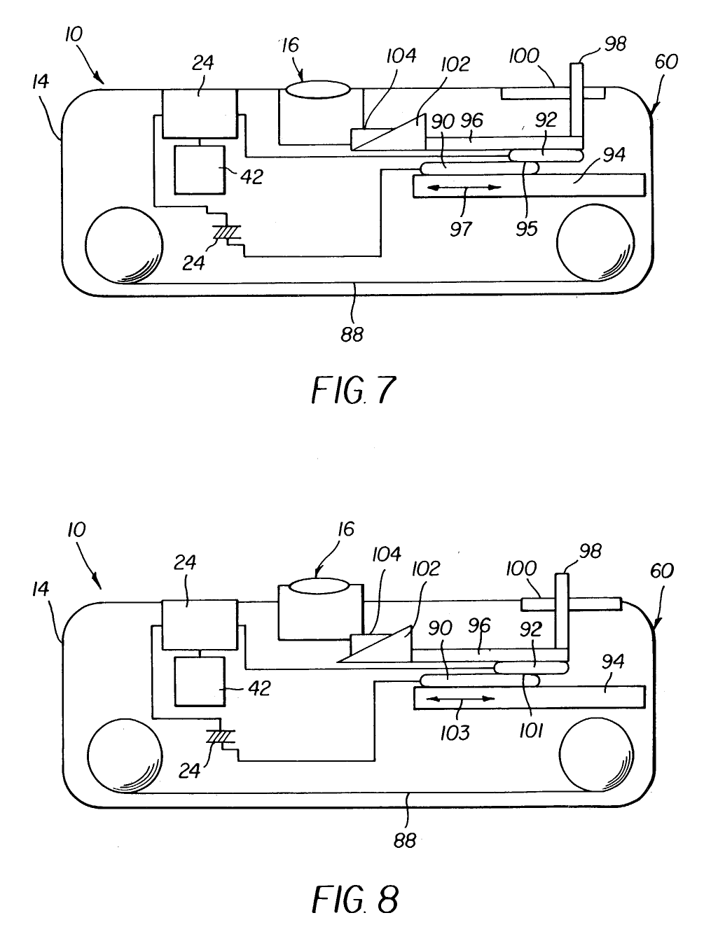

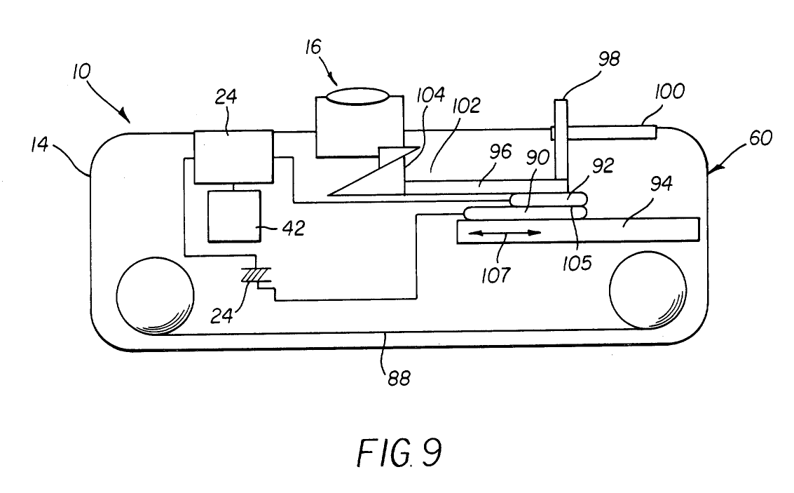

FIGS. 7, 8 and 9 show an alternative embodiment of a flash intensity control circuit 60 that can be used in accordance with the present invention. In this embodiment, flash intensity control circuit 60 comprises a stationary contact 90 and a movable contact 92 connected in series with flash illumination device 24 and flash capacitor 29. Stationary contact 90 comprises a section of a resistive material that is fixed to camera flash board 94 which is joined to camera body 14. Movable contact 92 also comprises a section of a resistive material. Movable contact 92 is joined to an adjustment member 96. As is shown in this embodiment, adjustment number 96 defines a projection 98 that extends through an opening 100 in camera body 14. Adjustment number 96 is slidably connected to camera frame 14 and is movable between a near position shown in FIG. 7, a range of intermediate positions one example of which is show in FIG. 8, and a far position shown in FIG. 9.

As shown in FIG. 7, when adjustment member 96 is positioned in the near position, stationary contact 90 partially engages a movable contact 92 defining a near position area of contact 95. When flash trigger circuit 42 causes flash energy to be discharged from the flash capacitor 29, in the form of electrical current, that passes through movable contact 92 through near position area of contact 95 and through a length 97 of movable contact 92. Length 97 is composed of a resistive material that imposes a load that is determined by the length of the resistive material. During a flash discharge, a portion of the energy discharged by flash capacitor 29 is consumed by this load which, in turn, reduces the amount of energy available to flash illumination device 24 during a flash discharge.

As is shown in FIG. 8 when adjustment member 96 is positioned in an intermediate position, stationary contact 90 engages movable contact 92 over an intermediate area of contact 101 that is larger than the near position area of contact 95. When flash energy is discharged from the flash capacitor 29 electrical current, the current passes through a length 103 of stationary contact 90 that is shorter than length 97 and imposes a load that is lower than the load in the near position. During a flash discharge, a portion of the energy discharged by flash capacitor 29 is consumed by this load which, reduces the amount of energy available to flash illumination device 24 during a flash discharge but does not reduce the amount of energy available to flash illumination device 24 to the same degree that occurs when adjustment member 96 is positioned in the intermediate position.

As is shown in FIG. 9, when adjustment member 96 is positioned in the far position, stationary contact 90 engages movable contact 92 over a far position area of contact 105 that is larger than the intermediate position area contact 101. Accordingly, when flash energy is discharged from flash capacitor 29 in the form of electrical current, the current passes through a length 107 of stationary contact 90 that is short enough so that essentially no additional load is imposed upon the current discharged by flash capacitor 29. This allows flash illumination device 24 to convert substantially all of the energy released by flash capacitor 29 into flash illumination to illuminate distant scenes. In this way, the flash control circuit 60 is switchable between various resistive positions wherein flash control circuit 60 applies a load and, the far position where flash control circuit 60 bypasses the resistive positions.

In the embodiment shown in FIG. 7, 8, and 9, adjustment number 96 is shown having an engagement surface 102 that is positioned to engage a co-designed mating surface 104 on optical system 16. As adjustment number 96 is moved from the near position shown in FIG. 7, to the far position shown in FIG. 9, engagement surface 102 its thrust against mating surface 104. This projects lens system 16 away from a photographic film 88, shifting the focused distance from a near focused position to a far focused position. In this way, adjustment number 96 performs the dual roles of adjusting the focused distance of camera 10 while also adjusting the positioning of movable contact 90 relative to stationary contact 92. It will be appreciated that, other adjustment member arrangements can be used such as mechanical transmissions, cam and follower arrangements, and other mechanical structures known in the art.

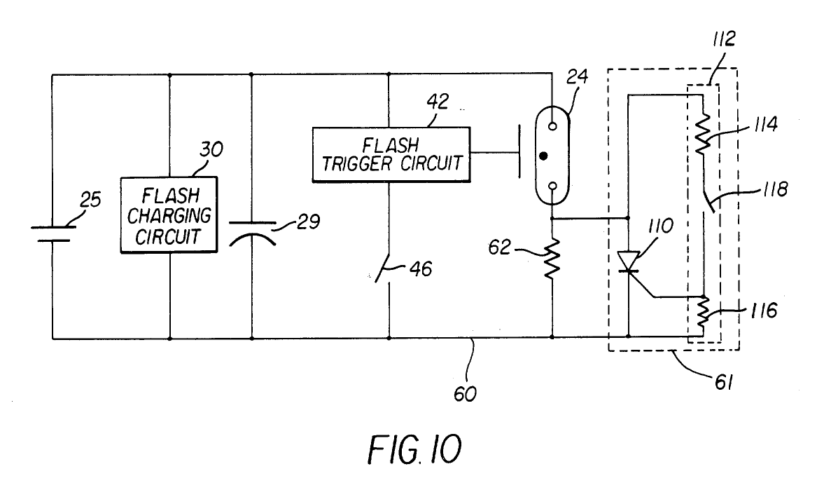

FIG. 10 shows yet another embodiment of a flash circuit 12 having a flash intensity control circuit 60. In this embodiment, bypass circuit 61 comprises a thyristor 110 and a gate bias circuit 112. As shown in FIG. 10, in this embodiment, thyristor 110 defines an electrical path that is electrically connected in parallel with a current limiting device 62 shown in this embodiment as a resistor. The gate of thyristor 110 is biased off by resistor 116 when control switch 118 is open. When thyristor 110 is biased off, thyristor 110 does not conduct electricity, and any energy discharged by flash capacitor 29 is shared between flash illumination device 24, shown in this embodiment as a flash tube and current limiting device 62. This lowers the amount of light emitted by flash illumination device 24 during the flash discharge.

When control switch 118 is closed, thyristor 110 is biased on at the instant of flash tube triggering by current flowing through resistor 114, through switch 118, to the gate of thyristor 110. This causes thyristor 110 to conduct and to bypass current limiting device 62. Where this occurs, the energy from flash capacitor 29 is not shared with current limiting device 62 and a full flash discharge can occur. Such a full flash discharge is suitable for distance photography.

A particular advantage of the embodiment of FIG. 10 is that the amount of energy used in flash discharge can be adjusted using a passive circuit that does not require a low voltage power source (e.g. battery power) in order to alter the state of thyristor 110. A further advantage of this embodiment, is that by placing bypass circuit 61 in parallel with current limiting device 62, it becomes possible to use a control switch 118 having a relatively low current rating.

It will be appreciated that a flash intensity control circuit 60 having more than two flash intensity settings can be formed and a multi-position switch with more than two flash intensity settings and with at least one setting associated with current limiting device 62, at least one setting associated with at least one additional current limiting device 64 and with at least one setting that bypasses each current limiting device wherein a thyristor is in parallel with each current limiting device.

In one embodiment described above, flash charging circuit 30 has been shown as a one touch flash charging circuit. However, other types of flash charging circuit 30 can be used including but not limited to other forms of one touch type flash charging circuits and so called press and hold flash charging circuits. Further, in various embodiments described above, flash illumination device has been shown as a flash tube with flash trigger circuit 42 shown being co-designed to discharge flash light from a flash tube. To the extent that other forms of flash illumination device 24 are used, such as are described above, flash trigger circuit 40 can take the form of known circuits that are capable of controlling the discharge of flash energy through such embodiments of flash illumination device 24.

The invention has been described in detail with particular reference to certain preferred embodiments thereof, but it will be understood that variations and modifications can be effected within the spirit and scope of the invention.

### PARTS LIST

10 camera

12 flash circuit

14 camera body

16 optical system

18 shutter button

19 “one touch” button

20 viewfinder

21 switch

22 flash assembly

24 flash illumination device

25 power supply battery

28 rectifier diode

29 flash capacitor

30 flash charging circuit

31 first oscillating transistor

32 second oscillating transistor

33 step-up oscillation transformer

34 transformer primary winding

35 transformer secondary winding

36 momentary switch

37 resistor

38 resistor

39 capacitor

40 flash illumination circuit

41 oscillation arresting circuit

42 flash trigger circuit

43 trigger capacitor

44 trigger pulse transformer

45 flash triggering electrode

46 flash trigger switch

47 isolation resistor

48 zener diode

49 oscillation arresting transistor

50 neon ready light

51 current limiting resistor

60 flash intensity control circuit

61 bypass circuit

62 current limiting device

64 additional current limiting device

70 system

72 stationary adjustable lens component

74 movable adjustable lens component

76 optical elements

78 imaging plane

80 movable contact

82 first stationary contact

84 second stationary contact

86 third stationary contact

88 photographic film

90 stationary contact

92 movable contact

94 camera flash board

95 near position area of contact

96 adjustable member

97 length

98 projection

100 opening

101 intermediate position area of contact

102 engagement surface

103 length

104 mating surface

105 far position area of contact

107 length

110 thyristor

112 gate bias circuit

114 resistor

116 resistor

118 control switch

What is claimed is:

1. A flash control circuit for a flash circuit having a flash capacitor and a flash illumination device, the flash control circuit comprising:
a current limiting device in series with the flash capacitor and flash illumination device; and
a bypass circuit in parallel with the current limiting device with the bypass circuit having a first setting that bypasses the current limiting device and a second setting that does not bypass the current limiting device.

2. The flash control circuit of claim 1, wherein the current limiting device comprises a resistor.

3. The flash control circuit of claim 2, wherein the current limiting device comprises a nickel chromium wire.

4. The flash control circuit of claim 1, wherein the current limiting device comprises an inductor.

5. The flash control circuit of claim 1, wherein the bypass circuit comprises a switch.

6. The flash control circuit of claim 1, wherein the bypass circuit comprises a voltage controlled switch in parallel with the current limiting device and a biasing circuit selectively generating a bias voltage for controllably setting the voltage controlled switch between an open setting and a closed setting.

7. The flash control circuit of claim 1, wherein the bypass circuit comprises a thyristor in parallel with the current limiting device and a biasing circuit for selectively generating a bias voltage for controllably setting the thyristor between an open setting and a closed setting.

8. The flash control circuit of claim 1, wherein the current limiting device comprises a length of a resistive material having a load that is determined by the length of the resistive material and wherein the bypass circuit comprises a movable contact that can be positioned to engage the length of resistive material within a range of positions including one position that bypasses the load.

9. A flash circuit comprising:
a flash illumination device;
a flash capacitor connected in series with the flash illumination device;
a flash charging circuit to store energy in the flash capacitor;
a trigger circuit to controllably discharge the energy stored in the capacitor through the flash illumination device so that the flash illumination device emits a flash of light;
a current limiting device in series with the flash capacitor and flash illumination device; and
a switch in parallel with the current limiting device with the switch being selectably settable between a closed setting that bypasses the current limiting device and an open setting that does not bypass the current limiting device, so that when the switch is open and a discharge of energy from the flash capacitor is triggered, the discharged energy is shared by the flash illumination device and the current limiting device.

10. The flash circuit of claim 9, wherein the current limiting device comprises a resistor.

11. The flash circuit of claim 9, wherein the current limiting device comprises an inductor.

12. The flash circuit of claim 9, wherein the current limiting device comprises a nickel chromium wire.

13. The flash circuit of claim 9, further comprising more than one current limiting device with each current limiting device having a different load and the switch is selectably settable between positions separately associated with one of the current limiting devices and a setting that bypasses the current limiting device.

14. The flash circuit of claim 9, wherein the switch comprises a voltage controlled switch in parallel with the current limiting device and said flash circuit further comprises a biasing circuit selectively generating a bias voltage for controllably adjusting the switch between an open setting and a closed setting.

15. The flash circuit of claim 9, wherein the switch comprises a thyristor in parallel with the current limiting device and said flash circuit further comprises a biasing circuit selectively generating a bias voltage for controllably adjusting the thyristor between an open setting and a closed setting.

16. The flash circuit of claim 9, having a multi-position switch with more that two flash intensity settings and with at least one setting associated with the current limiting device, at least one setting associated with at least one additional current limiting device and with at least one setting that bypasses each of the current limiting devices wherein a thryistor is in parallel with each of the current limiting devices.

17. A camera comprising:
a taking lens unit to focus light from a scene onto a film with the taking lens having adjustable optical setting;
a shutter system for controllably exposing the film to light from the scene;
a flash illumination device;
a flash capacitor connected in series with the flash illumination device;
a flash charging circuit to store energy in the flash capacitor;
a trigger circuit to controllably discharge the energy stored in the capacitor through the flash illumination device so that the flash illumination device emits a flash of light;
a current limiting device in series with the flash capacitor and flash illumination device; and
a switch in parallel with the current limiting device with the switch being selectably settable between a closed setting that bypasses the current limiting device and an open setting that does not bypass the current limiting device, so that when the switch is open and a discharge of energy from the flash capacitor is triggered, the discharged energy is shared by the flash illumination device and the current limiting device,
wherein the switch and the taking lens unit are joined so that the setting of the flash circuit is determined by the setting of the taking lens unit.

18. The camera of claim 17 further comprising an adjustment member for adjusting the setting of the taking lens unit, wherein the position of the adjustment member determines the setting of the switch.

19. The camera of claim 17, wherein the current limiting device comprises a length of a resistive material having a load that is determined by the length of the resistive material and wherein the bypass circuit comprises a conductor in parallel with the length of resistive material, the conductor having a movable contact that can be positioned to engage the length of resistive material within a range of positions including one position that bypasses the load.

20. The camera of claim 18 wherein the current limiting device comprises a length of a resistive material defining a current flow path having a load that is determined by the length of the resistive material and wherein the bypass circuit comprises a conductor in parallel with the length of resistive material, the conductor having a contact that is moved by the adjustment member to engage the length of resistive material within a range of positions including one position wherein the load is bypassed.

21. The camera of claim 17, further comprising more than one current limiting device with each current limiting device having a different load wherein the switch is selectably settable between positions separately associated with one of the current limiting devices and a setting that bypasses the current limiting devices.

22. The camera of claim 21, wherein the taking lens unit has at least one movable component that moves with changes in the focus distance wherein movement of said movable component sets the switch.

23. The camera of claim 17, wherein the taking lens unit has adjustable focus settings.

24. The camera of claim 17, wherein the taking lens unit has adjustable telephoto settings.
